(19) United States
(12) Patent Application Publication
(10) Pub. No.: US 2013/0276718 A1
(43) Pub. Date: Oct. 24, 2013

(54) APPARATUS FOR RETRACTION AND EXTENSION OF A LEASH OR OTHER FLEXIBLE MATERIAL

(71) Applicants: Oved Valadez, Portland, OR (US); Matthew Jones, Portland, OR (US)

(72) Inventors: Oved Valadez, Portland, OR (US); Matthew Jones, Portland, OR (US)

(73) Assignee: ROLLO PET COMPANY, LLC, Santa Monica, CA (US)

(21) Appl. No.: 13/450,690

(22) Filed: Apr. 19, 2012

(51) Int. Cl. A01K 27/00; B65H 75/48; B65H 75/44

(52) U.S. Cl. 119/796; 242/384.7; 242/379

(57) ABSTRACT

A mechanism for retracting and extending a length of flexible material including a gear mechanism having a toothed gear, a coil spring, and a stop mechanism. The stop mechanism includes a trigger button, at least one barb and latch combination and a gear tooth engaging member. Pushing the button a first time causes the barb to lock in the latch and causes the tooth engaging member to engage gear teeth, preventing movement of the gear and preventing extension or retraction of the flexible material. Pressing the button again releases the barb from the latch and disengages the tooth engaging member from the gear, enabling the gear to rotate to extend or wind up the flexible material.

### FIELD

The present disclosure relates to mechanisms for retracting a cord, leash, tape or other flexible length of material. More particularly, the present disclosure relates, in one exemplary embodiment, to a lockable leash retracting mechanism built into an animal collar.

### BACKGROUND

Collars and harness with leashes for restraining animals are known in the art. Also known in the art are collars with built-in retractable leash mechanisms. It would be desirable to have a built-in retractable leash mechanism that is easily manipulated with one hand so that the other hand may grasp the free end of the leash. It would be desirable to have such a mechanism operate with a single push button that would allow leash to be either paid out of the mechanism or retracted back into the mechanism.

### SUMMARY

The present disclosure provides in a first exemplary embodiment an apparatus for extending and retracting a length of flexible material, comprising (a) a bottom chassis having a central spool extending axially therefrom; (b) a gear having a generally flat disk-shaped plate having an edge with a plurality of teeth projecting outward therefrom and rim extending axially from the plate and having a rim inner wall and a rim exterior wall, the inner wall of the rim defining a gear well, the exterior wall of the rim defining a spool, the rim further having a slot formed therein; a coil spring disposed within the gear well; (c) a length of flexible material having a first end and a second end and adapted to be wound around the rim spool, a portion of the first end being fitted into the rim slot; (d) a top plate comprising a generally flat disk-shaped plate having a central hole; and, (e) a first ring having a flange, the ring being adapted to fit in the top plate central hole. The apparatus further includes a locking mechanism associated with the bottom chassis comprising a trigger button having a tooth engaging member for engaging at least one tooth of the gear, the trigger button further having an engaged position and a disengaged position, first and second arms extending from the trigger button, each arm having a shaft and at least one barb projecting from the shaft, each barb, first and second barb receiving latches, each latch, a spring associated with each arm for biasing the trigger button in the disengaged position, a first end of the spring being associated with a pin disposed on each arm, and a second end of the spring being associated with the bottom chassis, a top cover connectable to the lower chassis and having a slot formed therein through which the length of flexible material can pass. The apparatus may also include first and second opposing flexible wipers disposed proximate the slot through which the length of flexible material can pass and remove debris from the length of flexible material.

One aspect of the present disclosure provides an animal collar or leash with a built-in leash and a mechanism for controllably extending and retracting the leash.

Another aspect of the present disclosure provides a controllable extension and retraction assembly for a length of flexible material, such as a leash, rope, cord or the like. The assembly can be adapted for use in a variety of different applications, such as, but not limited to, rappelling, in a tape measure, with various spooling mechanisms, and the like.

One feature of the mechanism of the present disclosure is that the mechanism can be locked or unlocked to prevent extension or retraction by a “push-push” locking mechanism, thus facilitating one-hand use.

Other features will become apparent upon reading the following detailed description of certain exemplary embodiments, when taken in conjunction with the appended claims.

### BRIEF DESCRIPTION OF THE DRAWINGS

The drawings disclose exemplary embodiments in which like reference characters designate the same or similar parts throughout the figures of which:

FIG. 1 is a perspective exploded view of one exemplary embodiment of an apparatus of the present disclosure.

FIG. 2 is a perspective exploded view of the embodiment of FIG. 1.

FIG. 3 is an underside perspective view of the gear assembly and the locking mechanism.

FIG. 4 is an underside perspective view of a detail of the gear assembly, locking mechanism and the top cover.

FIG. 5 is a side elevational view of a detail of the top cover showing the slot and wiper elements.

FIG. 6 is a schematic view of one exemplary embodiment of the present disclosure featuring an animal collar with a built-in apparatus of the present disclosure.

FIG. 7 is a top plan view of the exemplary embodiment of FIG. 6.

FIG. 8 is a side elevational view of the exemplary embodiment of FIG. 6.

FIG. 9 is a top angle perspective exploded view of an exemplary embodiment of a locking mechanism in combination with an animal collar.

FIG. 10 is a bottom angle perspective exploded view of an exemplary embodiment of a locking mechanism in combination with an animal collar.

### DETAILED DESCRIPTION

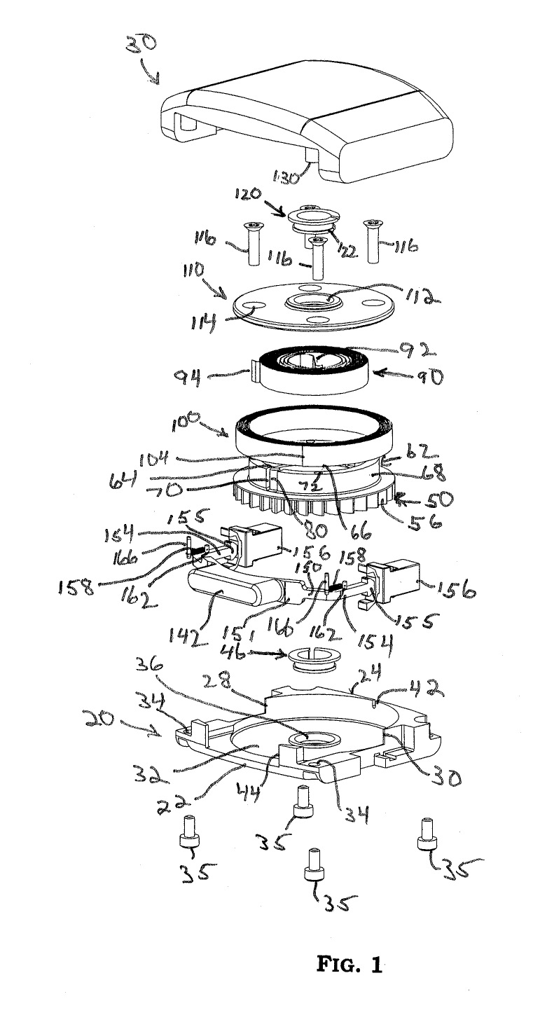

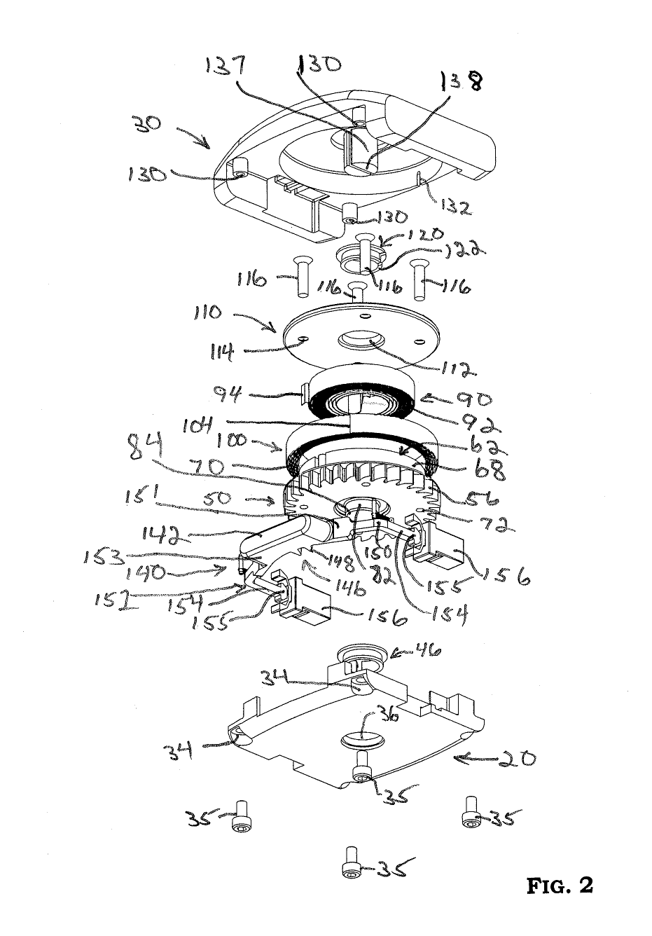

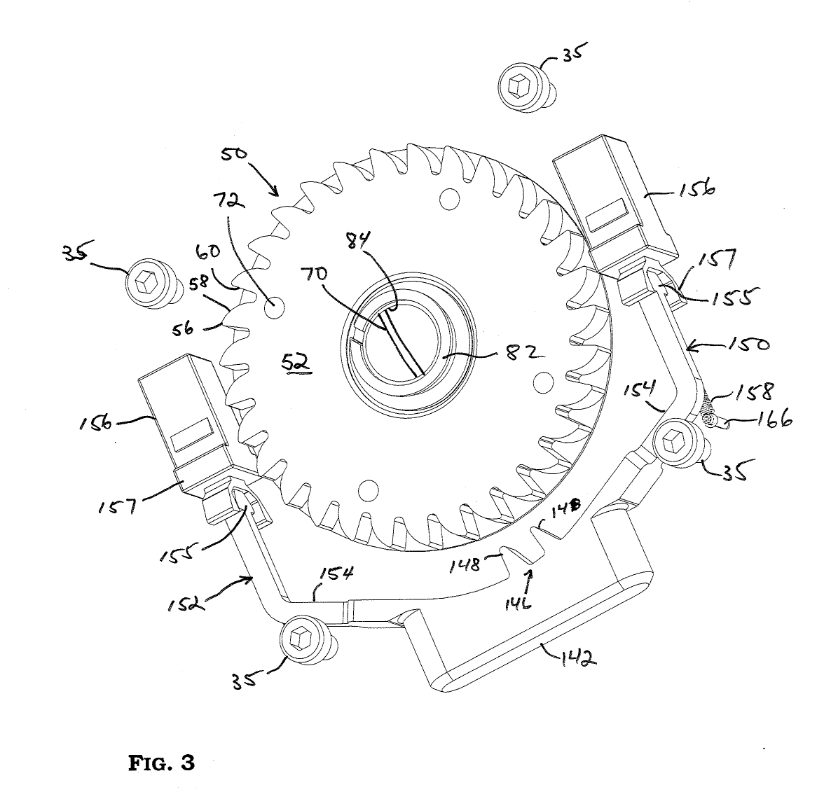

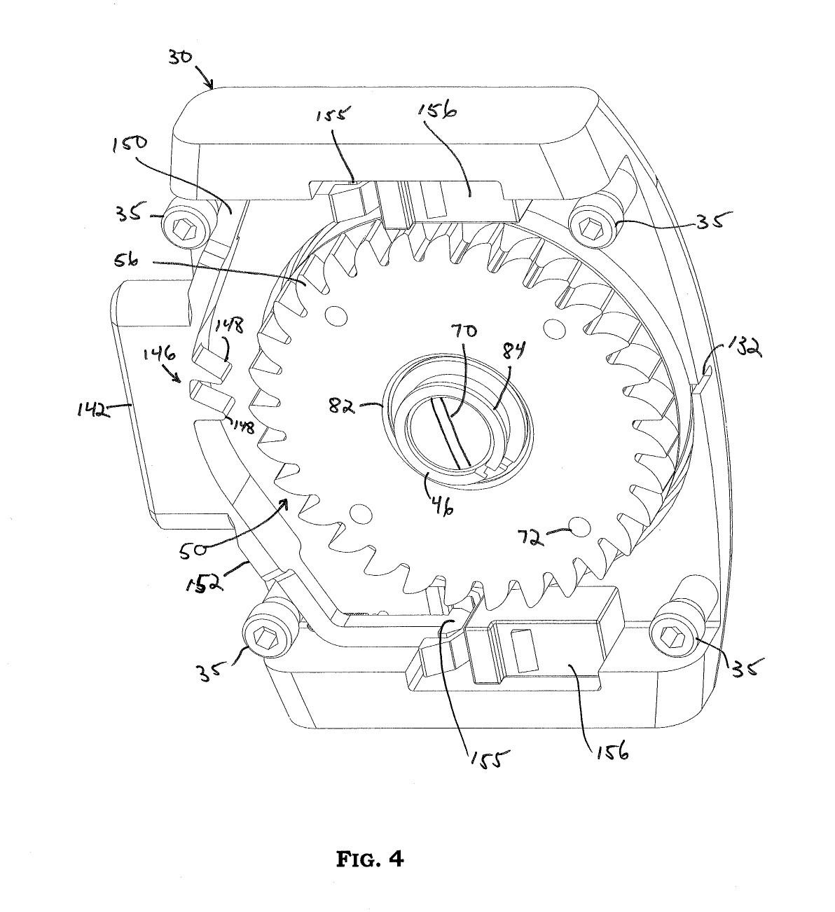

FIGS. 1-5 show one exemplary embodiment of a retraction apparatus 10 generally includes a bottom chassis 20, a top cover 30, a winding gear assembly 40.

The bottom chassis has a front 22, rear 24, bottom 26 and first and second sides 28, 30 and has a generally circular recess 32 to hold part of a winding gear assembly 40. The bottom chassis 20 may have several holes 34 each of which can receive a connector, such as a pin 35, bolt, screw or other fastener. A central opening 36 is in the center of the recess 32 of the bottom chassis 20. The bottom chassis 20 may have a slot 42 formed in the rear side wall 24. The bottom chassis 20 may be formed of any generally solid and rigid material, such as, but not limited to, plastic, metal, composite, combinations of the foregoing, and the like. In one exemplary embodiment, the bottom chassis 20 is made of plastic formed by, for example, injection molding. A C-shaped ring 46 is sized to fit over the central spool 36.

The retraction apparatus further comprises a gear assembly 40. The gear assembly 40 has a gear 50 having a surface 52 with a generally annular shape. The gear 50 has a perimeter edge 54 from which a plurality of teeth 56 extend outward and around the edge 54. In one exemplary embodiment either one or both edges of each tooth 56 are angled or curved within the gear plane, for example one wall of each tooth (e.g., the leading wall 58) may be generally vertical while the other wall (e.g., the trailing wall 60) may be angled or curved. A rim 62 extends axially upward from the gear surface 52. The inner wall 64 of the rim 62 defines a well 66. The rim 62 also is defined by an exterior wall 68. The rim 62 has a vertical slot 70 or recess or groove defined therein that may hold one end of a leash or other material, as discussed in detail hereinbelow. A pin 80 extends upward from the gear surface 52 and may be partially inset in a recess in the rim 62. A boss 82 extends downward from a central opening 84 in the gear and receives a spool 137, as described in further detail hereinbelow.

A coil spring 90 is disposed in the gear well 66. A center, first end 92 of the spring 90 is associated with the slot 138 in the central spool 137 as described hereinbelow. The outer, second end 94 of the spring 90 is connected to or abuts the pin 80 or tab extending from the gear 50, such as from the inner wall 64 of the gear. The spring 90 may be made of metal, composite or other material having sufficient properties to provide a spring force.

A length of flexible material 100 is provided, such as tape, metal, fabric, cord, mesh, weave, rope, thread (monofilament or multifilament), fiber, and combinations of the foregoing, or other material having sufficient strength and flexibility. In one exemplary embodiment, the material may be a leash, and the term “leash” will be used herein as a nonlimiting example solely for convenience, but it is to be understood that such term encompasses any of the foregoing materials or constructions referred to in this paragraph.

The leash has a first end 102 and a second end 104, the second end nominally considered a free end. The first end 102 may terminate in a thickened area 106, such as by doubling over the end of the material. The second end 104 may be free or attached to a handle 108, pull cord, tab, or other grasping device. The first end 102 can fitted in the gear rim slot 70 and the leash 100 can be wound around the exterior wall 68 of the rim 62.

In one exemplary embodiment the apparatus may include a top plate 110 that fits over the gear 50. The top plate 110 is generally disc shaped and has a central hole 112. The top plate 110 may have apertures 114 spaced around and proximate to the edge that can each receive a pin 116 or a bolt, screw or the like.

A locking ring 120 (which may be hollow) has a flange 122 that can fit in the top plate central hole 112 with the flange 114 resting on or in the hole 112.

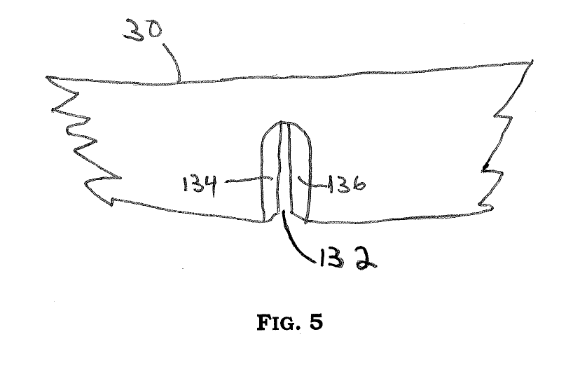

In one exemplary embodiment the apparatus may further include a top cover 30 that fits at least partially, and preferably totally, over the gear assembly 40, leash 100, and top plate 110. The top cover 30 may have a set of apertures 132 which can mate with complementary apertures 34 in the bottom chassis. The top cover may have a slot 132 or other shaped opening through which the leash 100 can pass. In one exemplary embodiment, the top cover slot 132 is aligned with the slot 42 in the bottom chassis 20. In one exemplary embodiment the slot formed by the top cover slot 132 and bottom chassis slot 42 is vertical. Alternatively, the top cover and the bottom chassis slots 132, 42 may be configured so that the combined slot is horizontal. Optionally, as shown in FIG. 5, the combined slot may have one or more (and preferably a pair) of flexible wiper elements 134, 136 through which the leash passes. The wiper elements remove dirt, debris and moisture from the leash 100 when the leash is retracted into the apparatus 10.

The top cover 30 has a central spool 137 extending downward, the spool having a slot 138 formed therein to receive the first end 92 of the coil spring 90.

A locking mechanism 140 assembly includes a trigger button 142 having a back side 144, at least one gear tooth engaging member 146, a pair of arm 150 and a pair of barb-receiving locking latches 156. The tooth engaging member 148 may have a plurality of tabs, barbs or teeth 148 extending from the back side 144 of the trigger button and sized and spaced to be able to engage one or more gear teeth 56 when the trigger button 142 is in the engaged and locked position with the gear 50. The tabs 148 are sized and shaped to intermesh with the gear teeth 56. In one exemplary embodiment the tabs 148 are angled or curved to match the angled or curved gear teeth 56. This curved or angled configuration increases the amount of pressure or force the mechanism can withstand when the leash 100 is subject to pulling stress.

In one exemplary embodiment a first arm 150 extends from a first edge 151 of the trigger button 142 and a second arm 152 extends from a second edge 153 of the trigger button 142. Each arm 150, 152 has a shaft 154 terminating in a barb 155. A latch 156 has a female receiving member 157 adapted to receive and selectively retain and release the barb 155. Such barb and latch mechanisms are known to those skilled in the art. One example of such a device is a touch latch PR-4PK commercially available from Sugatsune (www.sugatsune.com). Each latch 156 is associated with a side 28, 30 of the bottom chassis 20, such as by having a recess or slot in the bottom chassis into which the latch is received and mounted. The barb 155 can be inserted into the latch 156 and the latch will retain the barb 155 until the arm 150 or 152 is urged forward further into the latch 156, upon which the barb 155 is released and can be removed.

It is to be understood that the locking mechanism assembly 140 can alternatively have a single arm 150 and latch 156.

For each arm 150, 152 there is a small spring 158 that is attached at one end 160 to a pin 162 extending from the arm and attached at the other end 164 to a pin 166 extending from or associated with the bottom chassis 20. The small spring158 biases the arm 150, 152 away from the latch 156 and the trigger button 142 in the disengaged position. Alternatively, a different biasing device can be used, such as a piece of spring metal mounted to provide a biasing force, or an elastic band, or the like.

The apparatus may be assembled by inserting the coil spring 90 into the gear well 66. In one exemplary embodiment, shown in the figures, the gear 50 is positioned so that the gear well 66 faces upward toward the top plate 110. The leash 100 is assembled by inserting the first end 102 of the leash 100 into the slot 70 in the gear rim 62 so as to retain the leash 100. In one exemplary embodiment in which the first end 102 of the leash is thickened at area 106, the thickened portion 106 prevents the leash 100 from detaching from the rim 62. Alternatively, the first end 102 of the leash 100 may be attached to the rim 62 by a pin, hook or other retention device. The leash 100 is then wound around the rim 62. The gear 50 is fitted in the circular recess 32 in the bottom chassis 20. The second end 104 of the leash 100 is passed through the slot 42 in the bottom chassis 20 or the slot 132 in the top cover 30, or both, depending on the particular embodiment used.

In one exemplary embodiment the locking mechanism may be assembled as follows. The trigger button fits within an opening in the side of the bottom chassis and the tooth engaging member is positioned so as to be able to engage the gear teeth by horizontal movement toward or away from the gear teeth. The latches are mounted to opposing sides of the bottom chassis. The top cover fits over the apparatus and mates with the bottom chassis. The top cover and the bottom chassis can be connected by snap fit, bolts, a set of pins 166 and mating holes, or the like. The free end of the leash extends through the slot in the top cover and the bottom chassis.

In an alternative embodiment, the gear can be flipped upside down and the gear well can be underneath the gear surface. It is to be understood that the steps of assembly may be changed as the circumstances may favor or dictate.

In use, the apparatus is configured so that the leash is wound on the gear and the locking mechanism is in the locked position. When a user desires to extend the leash, he/she presses the trigger button, which urges (against the force of the small springs) the trigger toward the gear teeth. The tooth engaging member engages the teeth to prevent rotation of the gear and extension of the leash. Simultaneously, the barbs are urged into the latches and locked therein, maintaining the tooth engaging member engaged with the gear teeth.

To unlock the mechanism, the user again presses the trigger button, which causes each barb to be released from its respective latch and the tooth engaging member to be disengaged from the gear, permitting rotation of the gear and the user to pull leash from the gear (against the counter-force of the coil spring) or to permit the gear (urged by the rotational force exerted by the coil spring) to wind the leash around the gear, thereby retracting it inside the apparatus. The wiper can wipe the leash upon retraction to remove dirt, debris and moisture.

A feature of the present apparatus is the novel construction which has the coil spring, leash, gear and trigger button all being generally co-planar, resulting in a very compact and efficient design. Another feature of the present apparatus is that the trigger button can be activated by a “push-push” movement (similar to a retractable pen), rather than a “push-pull” movement, thereby making one-hand use easier.

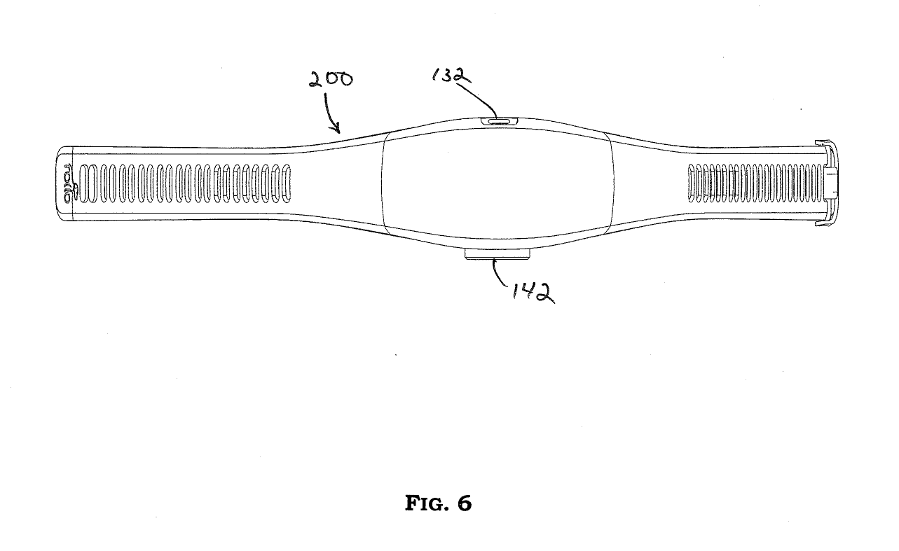

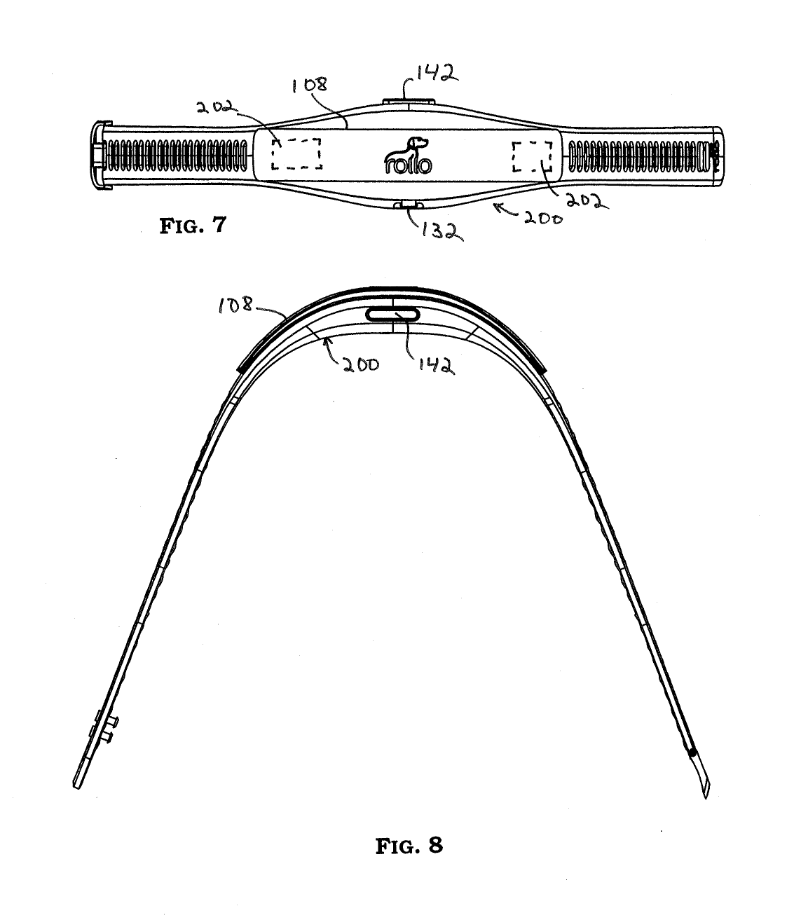

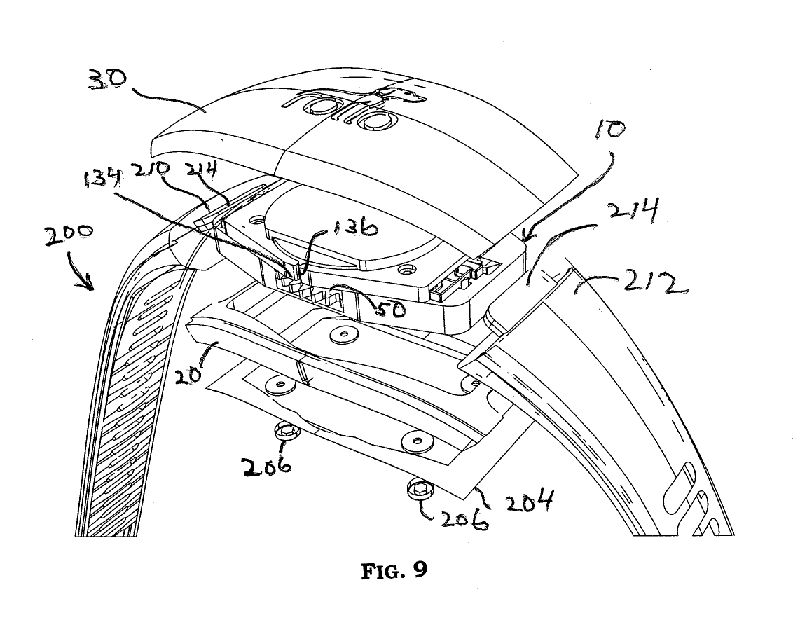

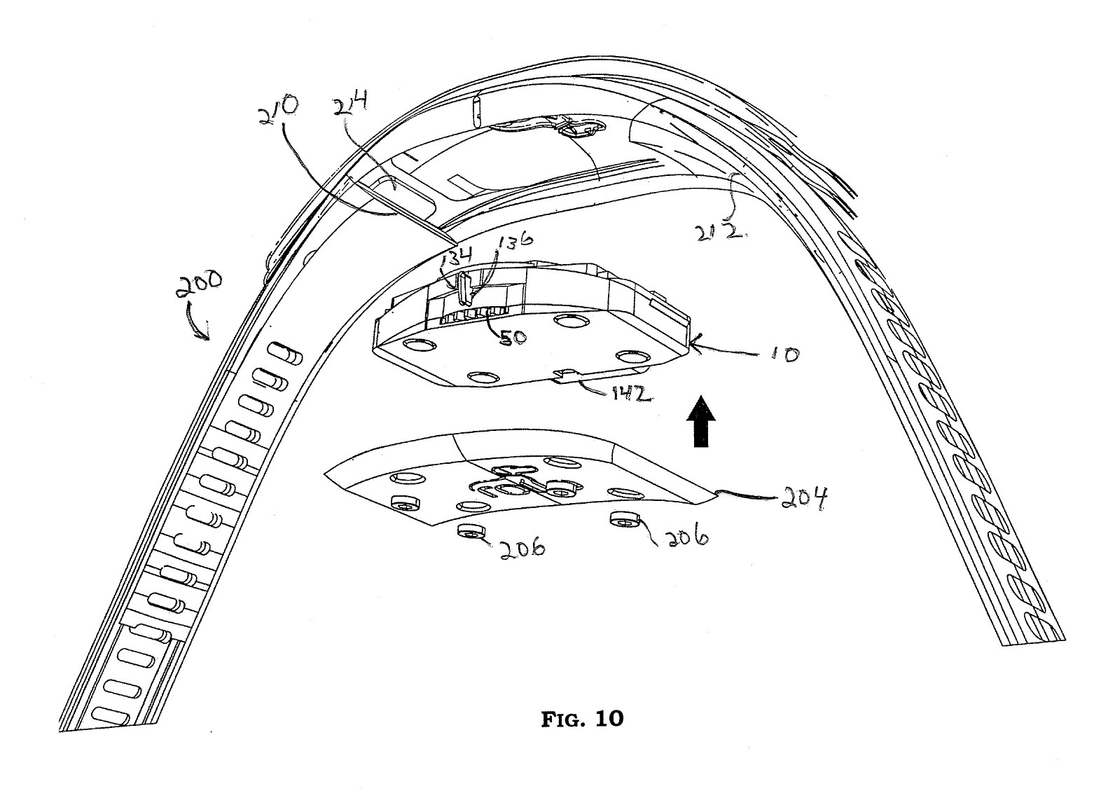

In one exemplary embodiment, the present apparatus is configured for use in an animal collar or harness and adapted to provide a retractable leash built into the collar or harness. While a collar is described in this embodiment, it is to be understood that the retraction apparatus can be used with a harness or other holding or wrapping arrangement. Further, the retraction apparatus can be used with other types of non-animal harnesses, such as, but not limited to, harnesses for children, inanimate objects, or the like. The apparatus can be adapted for heavier use by increasing the size, strength or length of various parts so that the apparatus can be used with a harness in rock or mountain climbing or other sporting activities. FIGS. 6-10 illustrates such an embodiment in which an animal collar 200 incorporates a leash retraction apparatus 10. The collar 200 has the retraction apparatus 10 mounted in or built in to the collar. The free end of the leash material can have a handle 108, carabiner or other type of end associated therewith. The handle may be removably attached to the collar by a magnet 202, hook-and-loop (e.g., Velcro) fastener, snaps, buttons, hooks, or other fastener system attached to one or both sides of the handle for storage when not in use. In use, the user grasps the handle with one hand and uses a finger to press the trigger button once to disengage the tooth engaging member. The apparatus 10 can be mounted in the collar 200 and maintained in place via a bottom cover plate 204, which is attached to the bottom chassis 20 by fasteners 206. In one exemplary embodiment a first end 210 and a second end 212 of the collar 200 are attached to the mechanism 10 via tabs 214 that fit into mating slots 216 (not shown). In one exemplary embodiment the locking mechanism assembly 10 and/or the collar 200 may be gasket or sonically welded around the chassis part line or the exposed areas to render it water resistant.

The leash 100 can then be extended partially or fully, with the first end of the leash 100 being retained in the gear slot 70. When sufficient leash 100 has been paid out, the user again presses the trigger button 142 to engage the tooth engaging member 146 and locking the barbs 155 into the latches 156, preventing the gear 50 from rotating and preventing more leash 100 from being paid out or from retracting. When the user wants to store the leash 100 in the collar 200 (within the locking mechanism 140), pushing the trigger button 142 disengages the tooth engaging member 146, and the coil spring 90 urges the gear 50 to rotate, thereby winding the leash 100 around the rim 62 of the gear 50 and storing the leash 100.

In one exemplary embodiment, an apparatus is provided comprising the gear assembly and bottom chassis, but not having the top cover or the bottom chassis corner apertures. In such an embodiment the gear assembly can be adapted for other applications and environments.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the methods, equipment and systems have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts. It should further be noted that any patents, applications and publications referred to herein are incorporated by reference in their entirety.

What is claimed is:

1. A mechanism for extending and retracting a length of flexible material, comprising:
a) a bottom chassis having a central spool extending axially therefrom;
b) a gear having
i) a generally flat disk-shaped plate having an edge with a plurality of teeth projecting outward therefrom;
ii) rim extending axially from the plate and having a rim inner wall and a rim exterior wall, the inner wall of the rim defining a gear well, the exterior wall of the rim defining a spool, the rim further having a slot formed therein;
c) a coil spring disposed within the gear well;
d) a length of flexible material having a first end and a second end and adapted to be wound around the rim spool, a portion of the first end being fitted into the rim slot;
e) a top plate comprising a generally flat disk-shaped plate having a central hole;
f) a first ring having a flange, the ring being adapted to fit in the top plate central hole;
g) a locking mechanism associated with the bottom chassis comprising
i) a trigger button having a tooth engaging member for engaging at least one tooth of the gear, the trigger button further having an engaged position and a disengaged position,
ii) first and second arms extending from the trigger button, each arm having a shaft and at least one barb projecting from the shaft, each barb,
iii) first and second barb receiving latches, each latch,
iv) a spring associated with each arm for biasing the trigger button in the disengaged position, a first end of the spring being associated with a pin disposed on each arm, and a second end of the spring being associated with the bottom chassis,
h) a top cover connectable to the lower chassis and having a slot formed therein through which the length of flexible material can pass;
i) first and second opposing flexible wipers disposed proximate the slot through which the length of flexible material can pass and remove debris from the length of flexible material.

2. The apparatus of claim 1, wherein the trigger button can move laterally in the same plane as the gear teeth so as to engage the gear teeth.

3. The apparatus of claim 1, wherein the apparatus further includes a means for wiping the flexible material of debris and moisture while the flexible material is being wound onto the gear.

4. A leash apparatus, comprising:
a) a retractable leash assembly comprising
i) a bottom chassis having a central spool extending axially therefrom;
ii) a gear having
a) a generally flat disk-shaped plate having an edge with a plurality of teeth projecting outward therefrom;
b) rim extending axially from the plate and having a rim inner wall and a rim exterior wall, the inner wall of the rim defining a gear well, the exterior wall of the rim defining a spool, the rim further having a slot formed therein;
iii) a coil spring disposed within the gear well;
iv) a length of flexible material having a first end and a second end and adapted to be wound around the rim spool, a portion of the first end being fitted into the rim slot;
v) a top plate comprising a generally flat disk-shaped plate having a central hole;
vi) a first ring having a flange, the ring being adapted to fit in the top plate central hole;
vii) a locking mechanism associated with the bottom chassis comprising
a) a trigger button having a tooth engaging member for engaging at least one tooth of the gear, the trigger button further having an engaged position and a disengaged position,
b) first and second arms extending from the trigger button, each arm having a shaft and at least one barb projecting from the shaft, each barb,
c) first and second barb receiving latches, each latch,
d) a spring associated with each arm for biasing the trigger button in the disengaged position, a first end of the spring being associated with a pin disposed on each arm, and a second end of the spring being associated with the bottom chassis,
viii) a top cover connectable to the lower chassis and having a slot formed therein through which the length of flexible material can pass;
ix) first and second opposing flexible wipers disposed proximate the slot through which the length of flexible material can pass and remove debris from the length of flexible material;
b) a collar or harness to which the leash assembly is associated; and,

5. a handle associated with the second end of the length of flexible material. The leash apparatus of claim 3, further comprising a retaining means for removably attaching the handle to the collar or harness.

6. A mechanism for extending and retracting a length of flexible material, comprising:
a) a gear having
i) a generally flat disk-shaped plate having an edge with a plurality of teeth projecting outward therefrom;
ii) rim extending axially from the plate and having a rim inner wall and a rim exterior wall, the inner wall of the rim defining a gear well, the exterior wall of the rim defining a spool, the rim further having a slot formed therein;
b) a coil spring disposed within the gear well;
c) a length of flexible material having a first end and a second end and adapted to be wound around the rim spool, a portion of the first end being fitted into the rim slot;
d) a top plate comprising a generally flat disk-shaped plate having a central hole;
e) a first ring having a flange, the ring being adapted to fit in the top plate central hole; and,
f) a locking mechanism comprising
i) a trigger button having a tooth engaging member for engaging at least one tooth of the gear, the trigger button further having an engaged position and a disengaged position,
ii) first and second arms extending from the trigger button, each arm having a shaft and at least one barb projecting from the shaft, each barb,
iii) first and second barb receiving latches, each latch, and,
iv) a spring associated with each arm for biasing the trigger button in the disengaged position, a first end of the spring being associated with a pin disposed on each arm, and a second end of the spring being associated with the bottom chassis.
